(19) United States
(12) Patent Application Publication
(10) Pub. No.: US 2014/0186534 A1
(43) Pub. Date: Jul. 3, 2014

(54) MASKING METHOD USED IN SURFACE TREATING PROCESS

(71) Applicant: HON HAI PRECISION INDUSTRY CO., LTD., New Taipei (TW)

(72) Inventors: CHANG-CHIN WU, New Taipei (TW); PEI-RONG SHIEH, New Taipei (TW)

(73) Assignee: HON HAI PRECISION INDUSTRY CO., LTD., New Taipei (TW)

(21) Appl. No.: 14/018,821

(22) Filed: Sep. 5, 2013

(30) Foreign Application Priority Data
Dec. 28, 2012 (TW) 101150754

(51) Int. Cl. B05C 21/00

(52) U.S. Cl. CPC B05C 21/005
USPC 427/300

(57) ABSTRACT

A masking method for a surface treating process provides an injector filled with infilling material and injecting the infilling material in holes having any shape or size or irregularity in a workpiece. The infilling material is cured to form a protective plug in the hole. The infilling material includes resin resistant to the surface treating process. The infilling material overfills the hole and partly protrudes out from the hole. The protective plug adheres to every inner surface of the hole to protect the inner surfaces of the hole from the surface treating process. Gripping and pulling on the partial protrusion of the protective plugs, that are formed from the cured resin, from the hole elastically reduces the original girth or diameter of the infilling material in the hole to allow easier physical removal.

### BACKGROUND

1. Technical Field

The present disclosure relates to masking methods, and particularly to a masking method for masking inner surfaces of holes of a workpiece in a surface treating process.

2. Description of the Related Art

During a surface treatment process, such as anodizing of a workpiece, holes of the workpiece can be protected from the treatment process by a masking method. In a masking method, protective rubber plugs are employed to block or plug the holes, such that the holes are protected from coatings and processes. However, if the holes are irregular or have a complicated shape, the protective rubber plugs cannot tightly adhere to the inner surfaces of the holes so as to completely block the holes. If the holes are too small, insertion of the protective rubber plugs is difficult.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 is a cross-sectional view of a workpiece including a plurality of holes to be protected by one embodiment of a masking method.

FIG. 2 is similar as FIG. 1, but showing infilling material filled into a hole of the workpiece of FIG. 1 by an injector.

FIG. 3 shows a cross-sectional view of a plurality of protective plugs protecting the holes of the workpiece of FIG. 1.

FIG. 4 is a table presenting testing results obtained from testing the protective plugs made from a plurality of infilling materials of various different material compositions, as examples, in accordance with the embodiment.

### DETAILED DESCRIPTION

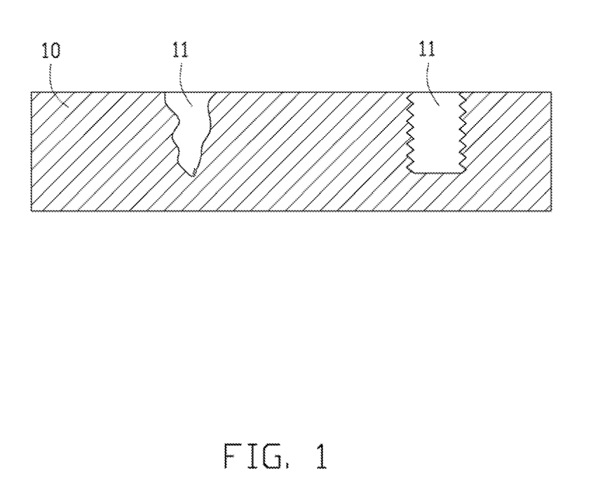

FIG. 1 shows a workpiece 10 having a plurality of holes 11. The workpiece 10 is to be anodized, and inner surfaces of the holes 11 are not to be treated. In one embodiment, the holes 11 are protected by a plurality of protective plugs 50. The holes 11 can be any shape, such as blind hole, threaded hole, or any irregular hole.

Infilling material employed in the embodiment includes resin, solvent, and additive agents. The resin is resistant to acid and alkali corrosion, and is selected from one or more from the group consisting of Styrene-Ethylene-Butylene-Styrene (SEBS) polymer, Styrene-Butylene-Styrene (SBS) polymer, Amorphous Poly Alpha Olefin (APAO), silicon rubber, epoxy resin, and polyurethane resin. The solvent is one or more organic solvents selected from the group consisting of isoparaffin, toluene, ethyl acetate, acetone, and butanone, as long as the solvent is capable of dissolving the resin. The one or more additive agents can be selected from the group consisting of diluents, curing agents, initiators, sensitizers, adhesion promoters, dispersing agents, wetting agents, thickening agents, and antifoaming agents. In other embodiments, when the original resin is gel-like, the additive agents are not required.

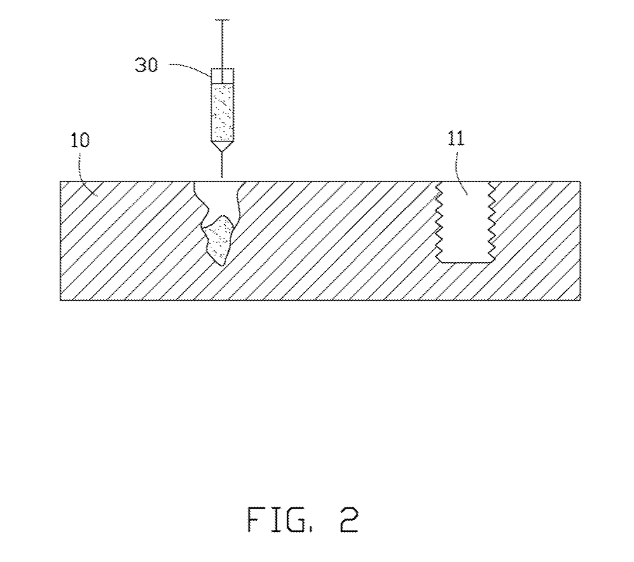

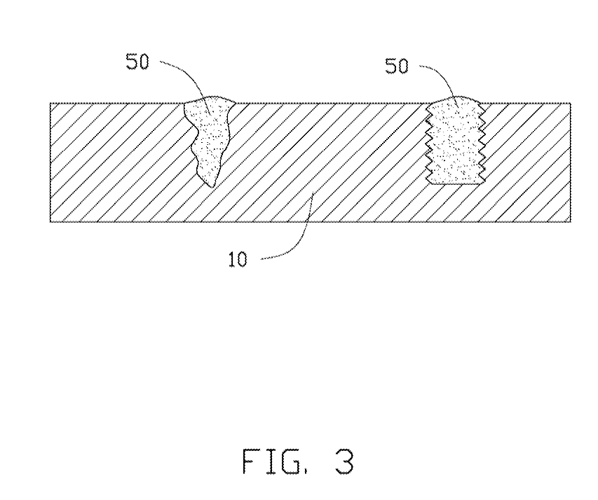

Referring also to FIGS. 2 and 3, one embodiment of a masking method for protecting the holes 11 of the workpiece 10 is as follows.

In step S101, an injector 30 filled with the infilling material is provided.

In step S102, the infilling material is injected by the injector 30 to fill the holes 11 to the extent of partly protruding out or extending beyond from the holes 11.

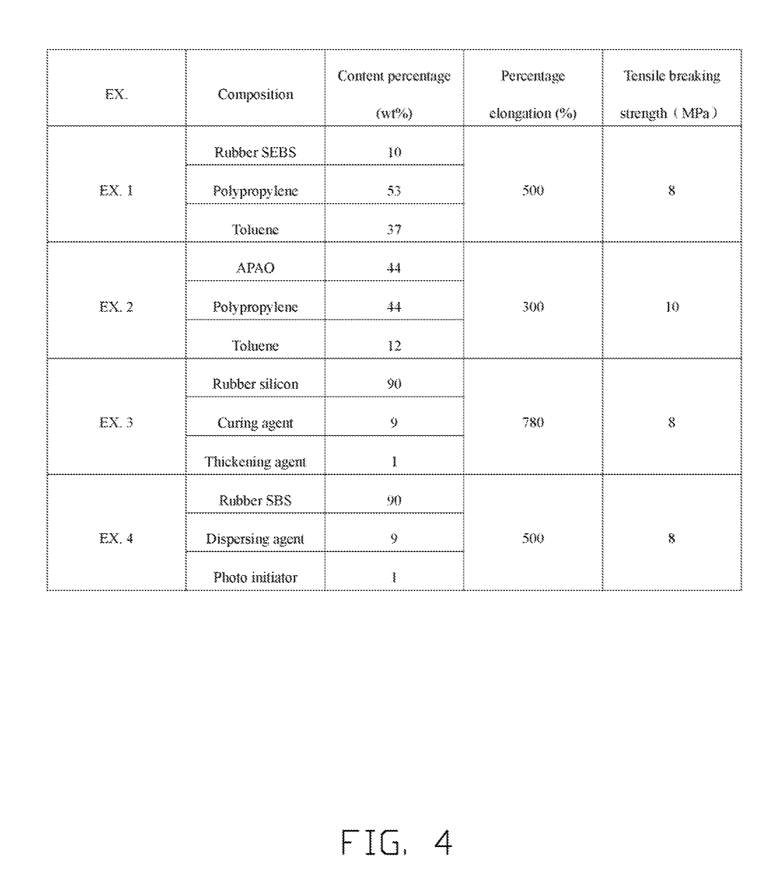

In step S103, the infilling material in the holes 11 is cured to form a plurality of protective plugs 50 for masking the holes 11. A percentage elongation of the protective plugs 50 is greater than or equal to 250%. A tensile breaking strength of the protective plugs 50 is greater than or equal to 7 MPa. A thermal curing method or a photocuring method can be employed to cure the infilling material after dispensing, depending on the type of infilling material being used. FIG. 4 shows a table presenting the testing results obtained from testing of the protective plugs using four examples of infilling materials to show the physical property performance of different infilling material compositions according to the embodiment in detail.

After anodizing, the protective plugs 50 can be physically detached from the workpiece 10 by pulling or extracting ends of the protective plugs 50 protruding from the holes 11.

Since the protective plugs 50 are formed by injecting the infilling material into the holes 11, thus even if the holes 11 are irregularly shaped or hard to access, the infilling material remain capable of fully filling the holes 11, such that the protective plugs 50 completely adhere to inner surfaces of the holes 11. Because of the predetermined percentage elongation and the tensile breaking strength that the protective plugs 50 possess, when pulling the protective plugs 50 from the workpiece 10, the protective plugs 50 are physically elongated and thus are elastically decreased in diameter (or girth) when being pulled, and are easily grasped for extraction, and difficult to break. In addition, the injection operation takes place easily in an automatic production line, such that a work efficiency is improved.

In other embodiments, when the workpiece 10 is treated by other surface treatment solution that are not acidic or alkaline, the resin is made to be resistant to the corresponding surface treatment. For example, if the workpiece 10 is to be treated by plating, the resin is resistant to plating solution.

Depending on the embodiment, some of the steps described above can be eliminated, while other additional steps can be added, and the sequence of steps can be changed. It is also to be understood that the description and the claims drawn to a method can include some indication in reference to certain steps. However, the indication used is only to be viewed for identification purposes and is not a suggestion as to an order for the steps.

It is to be understood, however, that even though numerous characteristics and advantages of the disclosure have been set forth in the foregoing description, together with details of the structure and function of the embodiments, the disclosure is illustrative only, and changes may be made in detail, especially in the matters of shape, size, and arrangement of parts within the principles of the embodiments to the full extent indicated by the broad general meaning of the terms in which the appended claims are expressed.

What is claimed is:

1. A masking method used in a surface treating process, comprising steps as follows:
providing an injector filled with an infilling material, the infilling material comprising a resin, the resin being resistant to the surface treating process;
injecting the infilling material by the injector to infill a hole of a workpiece, and the infilling material partly protruding out from the hole; and
curing the infilling material, thereby forming a protective plug in the hole, the protective plug adhering to inner surface of the hole to prevent the inner surface from being treated in the surface treating process.

2. The masking method used in the surface treating process of claim 1, wherein the resin is selected from one or more from the group consisting of styrene-ethylene-butylene-styrene polymer, styrene-butylene-styrene polymer, amorphous poly alpha olefin, silicon rubber, epoxy resin, and polyurethane resin.

3. The masking method used in the surface treating process of claim 1, wherein a percentage elongation of the protective plug is greater than or equal to 250%, and a tensile breaking strength of the protective plug is greater than or equal to 7 MPa.

4. The masking method used in the surface treating process of claim 1, wherein the hole is irregular or threaded.

5. The masking method used in the surface treating process of claim 1, wherein the infilling material further comprises an additive agent, the additive agent is selected from one or more from the group consisting of diluents, curing agent, initiator, sensitizer, adhesion promoter, dispersing agent, wetting agent, thickening agent, and antifoaming agent.

6. The masking method used in the surface treating process of claim 1, wherein the solvent is selected from one or more from the group consisting of isoparaffin solvent, toluene, ethyl acetate, acetone, and butanone.
